(19) United States
(12) Patent Application Publication
(10) Pub. No.: US 2013/0170480 A1
(43) Pub. Date: Jul. 4, 2013

(54) UPLINK RANDOM ACCESS DATA CHANNEL WITH HARQ

(71) Applicant: Research In Motion Limited, Waterloo (CA)

(72) Inventors: Robert Novak, Stittsville (CA); William Anthony Gage, Stittsville (CA)

(73) Assignee: Research In Motion Limited, Waterloo (CA)

(21) Appl. No.: 13/775,591

(22) Filed: Feb. 25, 2013

Related U.S. Application Data
(63) Continuation of application No. PCT/CA2011/050306, filed on May 16, 2011.

(51) Int. Cl. H04W 72/02

(52) U.S. Cl. CPC H04W 72/02
USPC 370/337; 370/329; 370/336

(57) ABSTRACT

Devices and methods are provided for managing random access data channels in a wirelessly-enabled communications environment. An uplink (UL) random access (RA) channel is implemented to send data to an access point (AP) without requiring a UL allocation grant message to be sent on the downlink (DL) for UL timing adjustments. A mobile station (MS) sends a chosen sequence to the AP to indicate that a RA data transmission is being requested. The location and number of radio resources that are used for the UL RA data transmission are determined by the choice of a RA sequence initially sent by the MS. If UL timing has not been established, the AP is able to determine the timing of the UL RA data transmissions by deriving the offset of the initial RA request sequence transmission from the MS.

### CROSS REFERENCE TO RELATED APPLICATIONS

This is a continuation of International Patent Application No. PCT/CA2011/050306, entitled “Uplink Random Access Data Channel With HARQ” by inventors Robert Novak and William Gage, filed on May 16, 2011, now pending, and incorporated by reference in its entirety.

International Patent Application No. PCT/CA2011/050306, entitled “Uplink Mobile Device Random Access Data Channel” by inventors Robert Novak and William Gage, filed on May 16, 2011, describes exemplary methods and systems and is incorporated by reference in its entirety.

### BACKGROUND

In some wireless systems, such as the 3GPP Long Term Evolution (LTE) system, initiating uplink (UL) communication between a mobile station (MS) and an access point (AP) requires the sending of a random access preamble signature from the MS to the AP. This signature is sent on a random access channel radio resource to establish timing, identity, and other communication parameters. In response, the MS receives a Random Access Response (RAR) message from the AP in a downlink (DL) communication, which may include information enabling UL timing and may likewise initiate an iterative process to realize UL synchronization. The MS subsequently receives an allocation of UL resources from the AP for an upcoming UL transmission opportunity. In some cases, the identity of the allocated UL resources is included in the RAR message. The MS then uses the allocated UL resources to send an UL message to the AP.

However, it is not uncommon for the MS to encounter communication difficulties on the UL when, for example, communicating to a non-serving access point (AP), when communicating to any AP after an idle period, or when dedicated UL resources are infrequently allocated to the MS. For example, there may be errors in UL timing as the MS may not have recently synchronized with the AP. As another example, there may be a delay in acquiring an UL resource allocation or timing advance from the AP. Yet another example includes the case where a large number of UL allocation or timing advance messages are required if many MS's simultaneously placed a request to send data on the UL. Furthermore, in some applications, such as those for machine-to-machine (M2M) communications, only a single short message needs to be transmitted infrequently on the UL by a MS. In such cases, a number of the fields in the RAR (e.g. 3GPP LTE type/extension, C-RNTI, timing advance) are superfluous.

Known approaches to these issues include the allocation of additional UL resources to allow control data to be sent along with a contention message on the UL, such as control data to facilitate a further allocation of UL transmission bandwidth. In this case, the number and location of the additional UL resources are fixed and can only be used to send small amounts of control data. In addition, known approaches to UL random access do not make efficient use of Hybrid Automatic Repeat reQuest (HARQ). As a result, modulation and coding schemes used are generally conservative, potentially leading to under-utilization of scarce radio resources.

### BRIEF DESCRIPTION OF THE DRAWINGS

The present disclosure may be understood, and its numerous objects, features and advantages obtained, when the following detailed description is considered in conjunction with the following drawings, in which:

FIG. 1 depicts an exemplary system node in which the present disclosure may be implemented;

FIG. 2 shows a wireless-enabled communications environment including an embodiment of a mobile station;

FIG. 3 is a simplified block diagram of a heterogeneous wireless network environment comprising a plurality of macro cells, micro cells, and pico cells;

FIG. 4 shows a process signal flow of a random access (RA) uplink (UL) data channel process utilizing Hybrid Automatic Repeat reQuest (HARQ);

FIG. 5 is a simplified schematic diagram showing the relationship between RA sequences, resources patterns (RPs), and UL resources;

FIG. 6 shows RA sequences, associated transmission opportunities, and corresponding ACKs for uplink (UL) RA data channels utilizing HARQ;

FIG. 7 is a simplified schematic diagram showing the relationship between RA sequences, RPs, and UL resources associated with the RA data channels shown in FIG. 6;

FIG. 8 shows RA sequences, associated transmission opportunities configured in the same time slot, and corresponding ACKs for uplink (UL) RA data channels utilizing HARQ;

FIG. 9 is a simplified schematic diagram showing the relationship between RA sequences, RPs, and UL resources associated with the RA data channels shown in FIG. 8;

FIG. 10 is an expanded Orthogonal Frequency-Division Multiple Access (OFDMA) subframe view of transmission opportunities ‘f’, ‘g’ and ‘h’ shown in FIG. 8,

FIG. 11 is an expanded view of OFDMA subframe ‘g’ shown in FIG. 10;

FIG. 12 is an expanded OFDMA subframe view of transmission opportunities ‘f’, ‘g’ and ‘h’ shown in FIG. 8, showing a configuration with extended cyclic prefixes and subframe guard time;

FIG. 13 is an expanded view of OFDMA subframe ‘g’ shown in FIG. 12;

FIG. 14 shows RA sequences, associated transmission opportunities, and corresponding ACKs for uplink (UL) RA data channels in which the number of dedicated random access resources is varied in each HARQ transmission opportunity;

FIG. 15 is a simplified schematic diagram showing the relationship between RA sequences, RPs, and UL resources associated with the RA data channels shown in FIG. 14;

FIG. 16 shows RA sequences, associated transmission opportunities, and corresponding ACKs for uplink (UL) RA data channels with a decreasing number of dedicated resources for all resource patterns (RPs) in successive HARQ transmission opportunities, and with an increased number of dedicated resources for the final HARQ transmission opportunity; and

FIG. 17 is a simplified schematic diagram showing the relationship between RA sequences, RPs, and UL resources associated with the RA data channels shown in FIG. 16.

### DETAILED DESCRIPTION

The present disclosure is directed in general to communications systems and methods for operating same. In one aspect, the present disclosure relates to devices and methods for managing random access data channels in a wirelessly-enabled communications environment.

An embodiment is directed to a system for transmitting data over a random access (RA) data channel comprising: a plurality of RA data channels, each RA data channel comprising: a RA sequence associated with a corresponding RA sequence identifier, a RA resource pattern (RP) comprising a set of uplink (UL) Hybrid Automatic Repeat reQuest (HARQ) transmission opportunities corresponding to a set of data transmission resources, each data transmission resource comprising a set of radio channel resources, and a mobile station (MS) configured to: select a RA data channel from the plurality of RA data channels, transmit the RA sequence associated with the selected RA data channel to an access point (AP), use the data transmission resources to transmit data to the AP during corresponding HARQ transmission opportunities of the RP associated with the selected RA data channel, and receive a data transmission positive or negative acknowledgement from the AP.

An embodiment is directed to a method for transmitting data over a random access (RA) data channel of a plurality of RA data channels comprising: associating a RA sequence with a corresponding RA sequence identifier, providing a RA resource pattern (RP) comprising a set of uplink (UL) Hybrid Automatic Repeat reQuest (HARQ) transmission opportunities corresponding to a set of data transmission resources, each data transmission resource comprising a set of radio channel resources, selecting a RA data channel from the plurality of RA data channels, transmitting the RA sequence associated with the selected RA data channel to an access point (AP), using the set of data transmission resources to transmit data to the AP during corresponding HARQ transmission opportunities of the RP associated with the selected RA data channel, and, receiving a data transmission positive or negative acknowledgement from the AP.

Devices and methods are provided for managing random access data channels in a wirelessly-enabled communications environment. In various embodiments, an uplink (UL) random access (RA) data channel is implemented to allow a mobile station (MS) to send data to an access point (AP) without requiring an explicit allocation of UL transmission resources to the MS and without the need to synchronize UL transmissions between the MS and the AP. In these and various other embodiments, a mobile station (MS) sends a chosen RA sequence to an AP to indicate that a RA data transmission is being requested. After an acknowledgement to the MS by the AP, the MS begins the RA data transmission. The resource pattern (RP) that defines the radio resources that are used for the UL RA data transmission, and the timing of the UL RA data transmission, is determined by the RA sequence initially chosen by the MS. If UL timing has not been synchronized between the AP and the MS, the AP is able to determine the relative timing of the UL RA data transmissions by deriving the timing offset of the initial RA request sequence transmission from the MS and by compensating for this timing offset during subsequent UL RA data transmissions from the MS.

In certain of these various embodiments, the resource pattern (RP) associated with each RA sequence is comprised of a plurality of Hybrid Automatic Repeat reQuest (HARQ) UL transmission opportunities and an associated set of data transmission resources. Those of skill in the art will recognize that the individual resources of each RP could also be applied to any number of multiple transmissions schemes such as Automatic Repeat request (ARQ), or forms of diversity combining such as space-time transmit diversity (STTD). It will likewise be recognized by skilled practitioners of the art that the disclosure provides a quick and efficient manner for a MS to communicate information to an AP, obviating the need for an extended network access sequence requiring timing adjustments and negotiation for dedicated UL transmission resources. One example of the disclosure's advantageous use is when a MS is communicating with APs other than its serving AP to mitigate interference. Another example is when a MS is communicating information to an AP after an idle period when timing or temporary MS identification is out-dated. Yet, another example is when a MS is communicating information to an AP where the opportunities to transmit on dedicated UL resources are infrequent. Still another example is when short information bursts are infrequently communicated to an AP from a sensor for machine-to-machine (M2M) communication.

In various embodiments, a MS selects a RA sequence that is associated with a RP comprising a set of HARQ transmission opportunities and a set of data transmission resources. The RP is then used for UL transmission of data from the MS to an AP. Together, the RA sequence and associated RP constitute a random access (RA) data channel. In certain embodiments, not all of the data transmission resources corresponding to the RP are assigned exclusively to that RP. In these and other embodiments, other RPs may be assigned use of the same data transmission resources in one or more HARQ transmission opportunities. In certain embodiments, the number of distinct data transmission resources dedicated for use by the set of RPs is varied in each HARQ transmission opportunity. In one embodiment, each HARQ transmission is positively or negatively acknowledged by the AP by addressing the acknowledgement to a RA sequence identifier associated with the RA channel. In another embodiment, a HARQ transmission is positively acknowledged by the AP upon successful decoding and the ACK is addressed to an MS identifier sent with the data transmission.

In one embodiment, the resources for data transmission associated with all RA channels are restricted to predetermined portions of the radio channel, such as a subframe or set of transmission symbols. In certain embodiments, the resources for data transmission associated with an RP may be re-allocated by the AP to other mobile stations if the associated RA sequence is not received by the AP. In various embodiments, the data transmission resources allocated for subsequent HARQ transmission opportunities in the RP may be re-allocated by the AP to other mobile stations when the data transmission sent in a HARQ transmission opportunity is successfully decoded and positively acknowledged by the AP.

In one embodiment, an MS identifier is added to, and sent with, the data transmission. In other embodiments, an MS identifier is encoded or modulated separately from the data transmission to assist with conflict resolution. In one embodiment, the correct reception of an RA sequence and allocation of data transmission resources associated with the corresponding RP is confirmed by a one-bit ACK indicator sent by the AP to one or more mobile stations. In another embodiment, the correct reception of an RA sequence and allocation of data transmission resources associated with the corresponding RP is confirmed by an ACK message sent by the AP to one or more mobile stations.

In various embodiments, a set of resources (e.g., a subframe) is designated for UL transmission according to the data transmission resources associated with all of the RPs. In another embodiment, an OFDMA data transmission resource comprises an extended cyclic prefix, a reduced number of symbols, extended guard bands, and an increased guard time to allow the UL transmission of data without UL synchronization. In one embodiment, the correct reception of an RA sequence and allocation of data transmission resources associated with the corresponding RP is confirmed by an ACK message including a UL timing advance based on the RA sequence received. In various embodiments, the AP compares the arrival time of the RA sequence to the AP timing of the UL subframe to estimate the timing offset of the data transmission in later HARQ transmission opportunities.

Various illustrative embodiments of the present disclosure will now be described in detail with reference to the accompanying figures. While various details are set forth in the following description, it will be appreciated that the present disclosure may be practiced without these specific details, and that numerous implementation-specific decisions may be made to the disclosure described herein to achieve the inventor's specific goals, such as compliance with process technology or design-related constraints, which will vary from one implementation to another. While such a development effort might be complex and time-consuming, it would nevertheless be a routine undertaking for those of skill in the art having the benefit of this disclosure. For example, selected aspects are shown in block diagram and flowchart form, rather than in detail, in order to avoid limiting or obscuring the present disclosure. In addition, some portions of the detailed descriptions provided herein are presented in terms of algorithms or operations on data within a computer memory. Such descriptions and representations are used by those skilled in the art to describe and convey the substance of their work to others skilled in the art.

As used herein, the terms “component,” “system” and the like are intended to refer to a computer-related entity, either hardware, software, a combination of hardware and software, or software in execution. For example, a component may be, but is not limited to being, a processor, a process running on a processor, an object, an executable, a thread of execution, a program, or a computer. By way of illustration, both an application running on a computer and the computer itself can be a component. One or more components may reside within a process or thread of execution and a component may be localized on one computer or distributed between two or more computers.

As likewise used herein, the term “node” broadly refers to a connection point, such as a redistribution point or a communication endpoint, of a communication environment, such as a network. Accordingly, such nodes refer to an active electronic device capable of sending, receiving, or forwarding information over a communications channel. Examples of such nodes include data circuit-terminating equipment (DCE), such as a modem, hub, bridge or switch, and data terminal equipment (DTE), such as a handset, a printer or a host computer (e.g., a router, workstation or server). Examples of local area network (LAN) or wide area network (WAN) nodes include computers, packet switches, cable modems, Data Subscriber Line (DSL) modems, and wireless LAN (WLAN) access points. Examples of Internet or Intranet nodes include host computers identified by an Internet Protocol (IP) address, bridges and WLAN access points. Likewise, examples of nodes in cellular communication include base stations, relays, base station controllers, home location registers, Gateway GPRS Support Nodes (GGSN), and Serving GPRS Support Nodes (SGSN).

Other examples of nodes include client nodes, server nodes, peer nodes and access nodes. As used herein, a mobile station is a client node and may refer to wireless devices such as mobile telephones, smart phones, personal digital assistants (PDAs), handheld devices, portable computers, tablet computers, and similar devices or other user equipment (UE) that has telecommunications capabilities. Such client nodes and mobile stations may likewise refer to a mobile, wireless device, or conversely, to devices that have similar capabilities that are not generally transportable, such as desktop computers, set-top boxes, or sensors. Likewise, a server node, as used herein, refers to an information processing device (e.g., a host computer), or series of information processing devices, that perform information processing requests submitted by other nodes. As likewise used herein, a peer node may sometimes serve as client node, and at other times, a server node. In a peer-to-peer or overlay network, a node that actively routes data for other networked devices as well as itself may be referred to as a supernode.

An access point, as used herein, refers to a node that provides a client node access to a communication environment. Examples of access points include cellular network base stations and wireless broadband (e.g., WiFi, WiMAX, etc.) access points, which provide corresponding cell and WLAN coverage areas. As used herein, a macrocell is used to generally describe a traditional cellular network cell coverage area. Such macrocells are typically found in rural areas, along highways, or in less populated areas. As likewise used herein, a microcell refers to a cellular network cell with a smaller coverage area than that of a macrocell. Such micro cells are typically used in a densely populated urban area. Likewise, as used herein, a picocell refers to a cellular network coverage area that is less than that of a microcell. An example of the coverage area of a picocell may be a large office, a shopping mall, or a train station. A femtocell, as used herein, currently refers to the smallest commonly accepted area of cellular network coverage. As an example, the coverage area of a femtocell is sufficient for homes or small offices.

The term “article of manufacture” (or alternatively, “computer program product”) as used herein is intended to encompass a computer program accessible from any computer-readable device or media. For example, computer readable media can include but are not limited to magnetic storage devices (e.g., hard disk, floppy disk, magnetic strips, etc.), optical disks such as a compact disk (CD) or digital versatile disk (DVD), smart cards, and flash memory devices (e.g., card, stick, etc.).

The word “exemplary” is used herein to mean serving as an example, instance, or illustration. Any aspect or design described herein as “exemplary” is not necessarily to be construed as preferred or advantageous over other aspects or designs. Those of skill in the art will recognize many modifications may be made to this configuration without departing from the scope, spirit or intent of the claimed subject matter. Furthermore, the disclosed subject matter may be implemented as a system, method, apparatus, or article of manufacture using standard programming and engineering techniques to produce software, firmware, hardware, or any combination thereof to control a computer or processor-based device to implement aspects detailed herein.

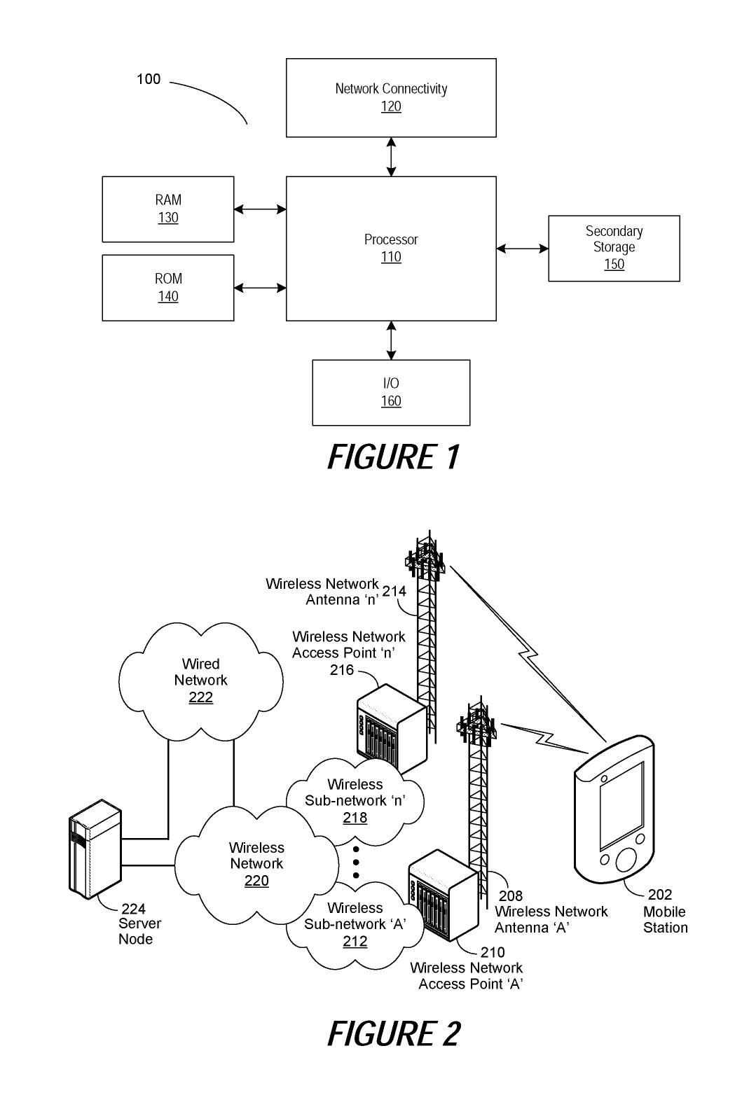

FIG. 1 illustrates an example of a system node 100 suitable for implementing one or more embodiments disclosed herein. In various embodiments, the system 100 comprises a processor 110, which may be referred to as a central processor unit (CPU) or digital signal processor (DSP), network connectivity interfaces 120, random access memory (RAM) 130, read only memory (ROM) 140, secondary storage 150, and input/output (I/O) devices 160. In some embodiments, some of these components may not be present or may be combined in various combinations with one another or with other components not shown. These components may be located in a single physical entity or in more than one physical entity. Any actions described herein as being taken by the processor 110 might be taken by the processor 110 alone or by the processor 110 in conjunction with one or more components shown or not shown in FIG. 1.

The processor 110 executes instructions, codes, computer programs, or scripts that it might access from the network connectivity interfaces 120, RAM 130, or ROM 140. While only one processor 110 is shown, multiple processors may be present. Thus, while instructions may be discussed as being executed by a processor 110, the instructions may be executed simultaneously, serially, or otherwise by one or multiple processors 110 implemented as one or more CPU chips.

In various embodiments, the network connectivity interfaces 120 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, long term evolution (LTE) radio transceiver devices, worldwide interoperability for microwave access (WiMAX) devices, and/or other well-known interfaces for connecting to networks, including Personal Area Networks (PANs) such as Bluetooth. These network connectivity interfaces 120 may enable the processor 110 to communicate with the Internet or one or more telecommunications networks or other networks from which the processor 110 might receive information or to which the processor 110 might output information.

The network connectivity interfaces 120 may also be capable of transmitting or receiving data wirelessly in the form of electromagnetic waves, such as radio frequency signals or microwave frequency signals. Information transmitted or received by the network connectivity interfaces 120 may include data that has been processed by the processor 110 or instructions that are to be executed by processor 110. The data may be ordered according to different sequences as may be desirable for either processing or generating the data or transmitting or receiving the data.

In various embodiments, the RAM 130 may be used to store volatile data and instructions that are executed by the processor 110. The ROM 140 shown in FIG. 1 may likewise be used to store instructions and data that is read during execution of the instructions. The secondary storage 150 is typically comprised of one or more disk drives or tape drives and may be used for non-volatile storage of data or as an overflow data storage device if RAM 130 is not large enough to hold all working data. Secondary storage 150 may likewise be used to store programs that are loaded into RAM 130 when such programs are selected for execution. The I/O devices 160 may include liquid crystal displays (LCDs), Light Emitting Diode (LED) displays, Organic Light Emitting Diode (OLED) displays, projectors, televisions, touch screen displays, keyboards, keypads, switches, dials, mice, track balls, voice recognizers, card readers, paper tape readers, printers, video monitors, or other well-known input/output devices.

FIG. 2 shows a wireless-enabled communications environment including an embodiment of a mobile station as implemented in an embodiment of the disclosure. Though illustrated as a mobile phone, the mobile station 202 may take various forms including a wireless handset, a pager, a smart phone, or a personal digital assistant (PDA). In various embodiments, the mobile station 202 may also comprise a portable computer, a tablet computer, a laptop computer, or any computing device operable to perform data communication operations. Many suitable devices combine some or all of these functions. In some embodiments, the mobile station 202 is not a general purpose computing device like a portable, laptop, or tablet computer, but rather is a special-purpose communications device such as a telecommunications device installed in a vehicle. The mobile station 202 may likewise be a device, include a device, or be included in a device that has similar capabilities but that is not transportable, such as a desktop computer, a set-top box, or a network node. In these and other embodiments, the mobile station 202 may support specialized activities such as gaming, inventory control, job control, task management functions, and so forth.

In various embodiments, the wireless network 220 comprises a plurality of wireless sub-networks (e.g., cells with corresponding coverage areas) ‘A’ 212 through ‘n’ 218. As used herein, the wireless sub-networks ‘A’ 212 through ‘n’ 218 may variously comprise a mobile wireless access network or a fixed wireless access network. In these and other embodiments, the mobile station 202 transmits and receives communication signals, which are respectively communicated to and from the wireless network points ‘A’ 210 through ‘n’ 216 by wireless network antennas ‘A’ 208 through ‘n’ 214 (e.g., cell towers). In turn, the communication signals are used by the wireless network access points ‘A’ 210 through ‘n’ 216 to establish a wireless communication session with the mobile station 202. As used herein, the network access points ‘A’ 210 through ‘n’ 216 broadly refer to any access node of a wireless network. As shown in FIG. 2, the wireless network access points ‘A’ 210 through ‘n’ 216 are respectively coupled to wireless sub-networks ‘A’ 212 through ‘n’ 218, which are in turn connected to the wireless network 220.

In various embodiments, the wireless network 220 is coupled to a wired network 222, such as the Internet. Via the wireless network 220 and the wired network 222, the mobile station 202 has access to information on various hosts, such as the server node 224. In these and other embodiments, the server node 224 may provide content that may be shown on the display 204 or used by the mobile station processor 110 for its operations. Alternatively, the mobile station 202 may access the wireless network 220 through a peer mobile station 202 acting as an intermediary, in a relay type or hop type of connection. As another alternative, the mobile station 202 may be tethered and obtain its data from a linked device that is connected to the wireless network 212. Skilled practitioners of the art will recognize that many such embodiments are possible and the foregoing is not intended to limit the spirit, scope, or intention of the disclosure.

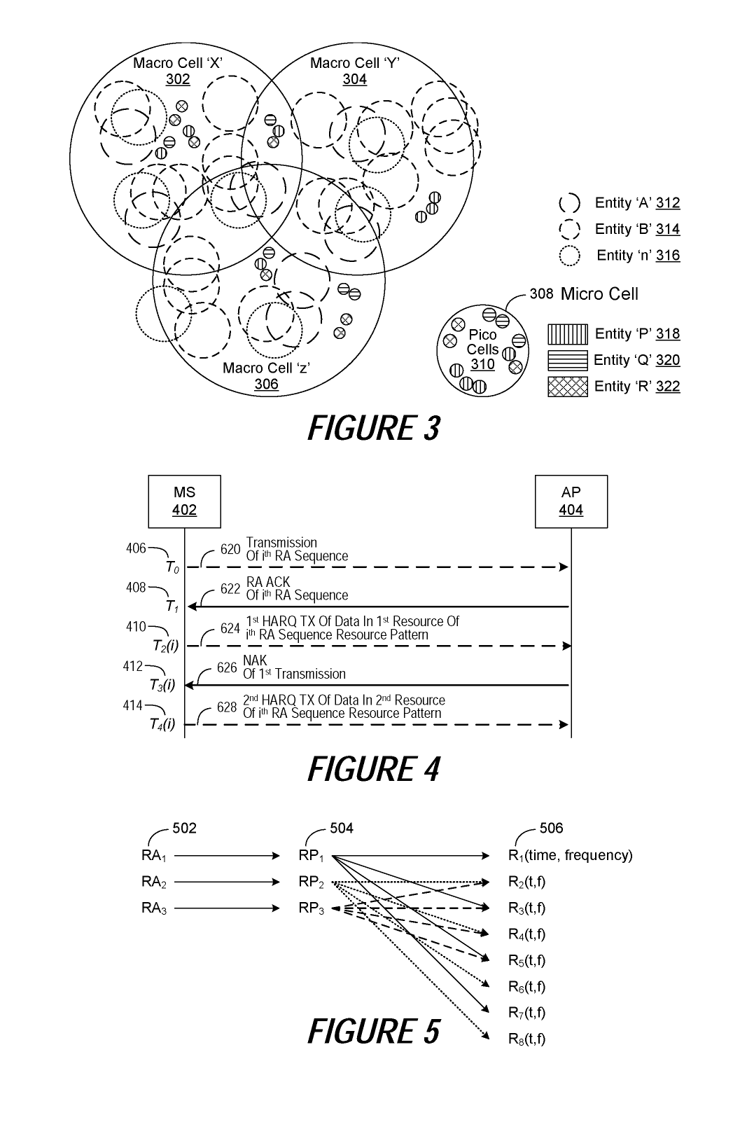

FIG. 3 is a simplified block diagram of a heterogeneous wireless network environment comprising a plurality of macro cells, micro cells, and pico cells as implemented in accordance with an embodiment of the disclosure. In this embodiment, a heterogeneous wireless network environment comprises a plurality of wireless network macro cells ‘X’ 302, ‘Y’ 304 through ‘z’ 306. In this and other embodiments, each of the wireless network macro cells ‘X’ 302, ‘Y’ 304 through ‘z’ 306 may comprise a plurality of wireless network micro cells 308, which in turn may comprise a plurality of wireless network pico cells 310. Likewise, the wireless network macro cells ‘X’ 302, ‘Y’ 304 through ‘z’ 306 may also comprise a plurality of individual wireless pico cells 310.

In various embodiments, the micro cells 308 may be associated with entity ‘A’ 312, ‘B’ 314 through ‘n’ 316, and the pico cells 310 may likewise be associated with entity ‘P’ 318, ‘Q’ 320 through ‘R’ 322. In these various embodiments, the wireless macro cells ‘X’ 302, ‘Y’ 304 through ‘Z’ 306, micro cells 308, and pico cells 310 may comprise a plurality of wireless technologies and protocols, thereby creating a heterogeneous operating environment within the wireless network system 300. Likewise, each of the wireless macro cells ‘X’ 302, ‘Y’ 304 through ‘z’ 306, micro cells 308, and pico cells 310 comprises a corresponding access point (AP). As used herein, an AP is a generic term that broadly encompasses wireless LAN access points, macro cellular base stations (e.g., NodeB, eNB), micro- and pico-cells, relay nodes and home-based femto cells (e.g., HeNB), or any telecommunications technology operable to establish and sustain a wireless communication session. As likewise used herein, a “cell” (or “sector”) is a portion of the coverage area served by an AP. According, each cell has a set of radio resources that can be associated with that cell through, for example, a unique cell identifier.

In view of the foregoing, there is a need for efficiently communicating information from a MS to an AP through a random access (RA) data channel. An RA data channel is useful in the heterogeneous wireless network environment of FIG. 3 where an MS needs to coordinate with a neighboring, but non-serving AP. In addition, a parallel need is emerging for enabling the transmission of wireless reports from a machine or sensor to a network AP. Reports from such sensors, such as water or gas meters, atmospheric sensors, etc. result in the transmission of a relatively small amount of data. However there may be a great number of these sensors, even in a small cell area. As a result, it is not desirable to use conventional initial access, time synchronization, identification, and resource allocation methods to transfer the data due to the relatively large amount of signaling and time delay required to access the system before sending the short message. Likewise, the RA data channel can reduce the amount of battery power required to send data to the system thus extending the battery life in mobile stations of all types.

FIG. 4 shows a process signal flow of a random access uplink (UL) data channel process as implemented in accordance with an embodiment of the disclosure to utilize Hybrid Automatic Repeat reQuest (HARQ). In certain embodiments, a mobile station (MS) 402 sends data to an access point (AP) 404 on the UL by first transmitting a Random Access (RA) sequence and then subsequently transmitting the data over the UL resources associated with the RA sequence. In this embodiment, at some time T₀ 406 the MS 402 transmits 620 the i^{th} random access (RA) sequence to the AP 404. In this and other embodiments, the i^{th} RA sequence is selected by the MS 402 from a set of RA sequences that may be pre-configured in the MS 402, broadcast periodically by the AP 404, or determined by some other means. In various embodiments, the i^{th} RA sequence is selected at random from the set of RA sequences by the MS 402. In various other embodiments, the i^{th} RA sequence is randomly selected by the MS 402 from the set of RA sequences according to the amount of data that the MS 402 wishes to send to the AP 404. In these various embodiments, the RA sequence indicates to the AP 404 that a random access data transmission is being requested.

Then, at some time T₁ 408, the AP 404 sends 622 a positive acknowledgment (ACK) indicating it has received a transmission of the i^{th} sequence. No acknowledgement is transmitted if the AP 404 does not receive the sequence. In some embodiments, the ACK is indicated in a manner that relates to the i^{th} sequence, such as the time-frequency location of the ACK, or by explicitly indicating the RA sequence ID in an ACK message. In certain other embodiments, the ACK is indicated in a manner that relates to one or more RA sequences including the i^{th} sequence such as the time-frequency location of the ACK for a set of RA sequences, or by explicitly indicating the IDs for the set of RA sequences in an ACK message.

At some time T₂(i) 410, the MS 402 transmits 624 a first Hybrid Automatic Repeat reQuest (HARQ) transmission of data to the AP 404 on a set of radio resources using a pattern of transmission resources associated with the i^{th} sequence. In various embodiments, other RA sequences may have other transmission resource patterns associated with them. In certain of these embodiments, the AP 404 may improve reception by making use of the timing of the initial RA sequence to determine the time offset of the UL transmission by the MS 402. In these and other embodiments, the number of resources in the pattern of transmission resources is defined by the sequence chosen by the MS 402, which provides an implicit bandwidth request related to the size of the message that the MS is transmitting to the AP.

Then, at some time T₃(i) 412, the AP 404 sends a positive or negative acknowledgment (ACK or NAK) 626 indicating whether or not it has successfully decoded the last data transmission. If an ACK is received by the MS 402, it discontinues further data transmissions. However, if a NAK is received by the MS 402, then at some time T₄(i) 414, the MS 402 transmits 628 its next HARQ data transmission to the AP 404 on the second set of transmission resources associated with the i^{th} sequence and the HARQ process is continued. It will be appreciated by those of skill in the art that various other RA sequences may have other patterns of transmission resources associated with them.

FIG. 5 is a simplified schematic diagram showing the relationship between random access (RA) sequences, resources patterns (RP), and UL transmission resources (R), as implemented in accordance with an embodiment of the disclosure. In various embodiments, a random access sequence is selected by a mobile station (MS) from a set of RA sequences available at an access point (AP). In certain of these embodiments, the available RA sequences may be broadcast by the AP through some means such as the Master Information Block (MIB) or System Information Block (SIB) used in Long Term Evolution (LTE) systems. In these various embodiments, specific transmission resources are designated, but not necessarily dedicated, for the RA sequence transmission opportunities. Likewise, the timing of Hybrid Automatic Repeat reQuest (HARQ) transmissions opportunities at which these transmission resources can be used can be adaptively changed by the AP according to traffic load.

Likewise, dependent upon the implementation, the RA sequence may be transmitted in frequency, using one element of the sequence per subcarrier, or in time domain, where each element of the RA sequence is transmitted sequentially in time. In order to accommodate errors in time synchronization between different mobile station's UL transmission arrivals at the AP, the time-frequency resources for RA reception may likewise span multiple symbols due to the use of guard intervals and may use a longer cyclic prefix.

In certain embodiments, the selection and transmission of a RA sequence is implemented as initial random access sequences as defined in cellular systems such as LTE or Worldwide Interoperability for Microwave Access (WiMAX) systems. As described in greater detail herein, and differing from known approaches, the present disclosure associates each RA sequence with a predetermined set of transmission opportunities for RA data transmission. In these and other embodiments, the RA sequence is associated with a predetermined pattern of time-frequency resources for the upcoming data transmission from the MS, obviating the need for messages from the AP to explicitly allocate uplink resources to the MS or to adjust UL transmission timing.

In various embodiments, the AP responds to the reception of an RA sequence with an ACK. In certain of these embodiments, the ACK is indicated in a manner that relates to the i^{th} sequence, such as the time-frequency location of the ACK, or by a corresponding ACK bit in an acknowledgement bit map. The ACK may likewise be indicated by sending an ACK as a sequence in a time-frequency space reserved for a RA ACK where each ACK sequence corresponds to a received RA sequence, or by explicitly indicating the RA sequence ID in an ACK message. In certain embodiments, the ACK is indicated in manner that relates to one or more sequences including the i^{th} sequence such as the time-frequency location of the ACK for a set of sequences. Likewise, the ACK may indicate the ID for the set of sequences in an ACK message. In one embodiment, the AP transmits a single ACK if it receives one or more RA request sequences.

In these and other embodiments, reception of the RA ACK from the AP indicates to the MS that it may proceed with at least the first transmission of its data packet in the first set of time-frequency resources associated with RA sequence. If an RA ACK is not received by the MS where the configuration requires it, then the MS may not proceed with transmission on the resources associated with the RA sequence sent. Instead, the MS may begin the procedure again at the next opportunity, starting with selecting another RA sequence. In certain embodiments, the MS may wait a randomly selected time (i.e. random backoff) prior to its next attempt. Likewise, the MS may discard this information and not re-attempt transmission in cases where the information is time sensitive such that the delay has rendered the information out of date (i.e. CQI feedback, etc.).

As described in greater detail herein, a RA sequence is associated with a predetermined pattern of transmission resources for upcoming data transmission opportunities on the UL from the MS. The pattern defines the location and number of radio resources in the time, frequency and code domains. The association of an RA sequence to a resource pattern can be derived from predefined configurations, as well as information broadcast by the AP, such as the number of RA sequences and the number and location of the resources for the RA data channel. Each pattern defines a set of transmission resources for each possible HARQ transmission from an MS, where the time separation between successive transmissions is at least as long as the minimum time needed for the MS to receive an ACK/NAK response from the AP.

As with the RA ACK, the HARQ ACK for the RA data channel is indicated in certain embodiments in a manner that relates to the i^{th} sequence. For example, it may be indicated by the time-frequency location of the ACK, or by a corresponding ACK bit in an acknowledgement bit map. As another example, it may be indicated by sending an ACK as a sequence in a time-frequency space reserved for the ACK where each ACK sequence corresponds to a received RA sequence (or resource pattern). As yet another example, it may be indicated by the sequence ID in an ACK message. In certain embodiments, the ACK is addressed to the MS ID or identifier sent in with the data transmission and a HARQ transmission is positively acknowledged by the AP upon successful decoding.

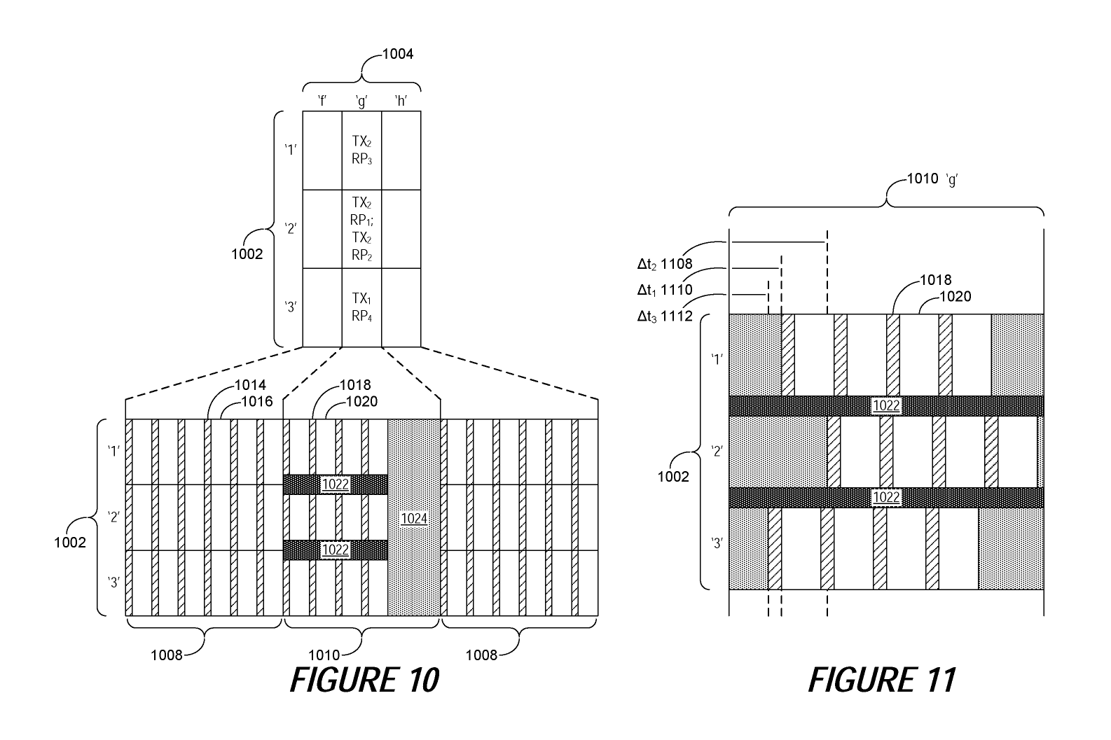

Referring now to FIG. 5, the relationship between RA sequences 502, resources patterns (RP) 504, and UL resources (R) 506 is shown. As shown in FIG. 5, RA sequence ‘1’ (RA₁) is associated with resource pattern ‘1’ (RP₁), which in turn comprises opportunities for transmission on the UL at resources R₁, R₃, R₅ and R₇. Likewise, RA sequence ‘2’ (RA₂) is associated with resource pattern ‘2’ (RP₂), which in turn comprises opportunities for transmission on the UL at resources R₂, R₄, R₆ and R₈. As likewise shown in FIG. 5, RA sequence ‘3’ (RA₃) is associated with resource pattern ‘3’ (RP₃), which in turn comprises opportunities for transmission on the UL at resources R₂, R₃, R₄ and R₅. In comparison to transmission from synchronized mobile stations using other means, the symbol structure or transmission format may be slightly different for transmission on the UL RA data channel in certain embodiments due to lack of synchronization of the incoming UL transmissions; which is exemplified in this document in FIGS. 10, 11, 12 and 13. This can be configured by the AP based on traffic and cell topology.

Accordingly, the AP has knowledge of the resources that are going to be used by each MS as the reception of a RA sequence indicates that a particular set of resources have been claimed by a given MS. As a result, the AP can ensure that other mobile stations are not scheduled by other means to use the claimed UL resources. Alternatively, the AP can schedule mobile stations on RA resources that are not claimed by any MS and do so using other scheduling methods. Likewise, the AP can exploit spatial separation between various mobile stations and respectively schedule them on the claimed resources by selective pairing the RA MS with another MS that will facilitate spatial division at the AP.

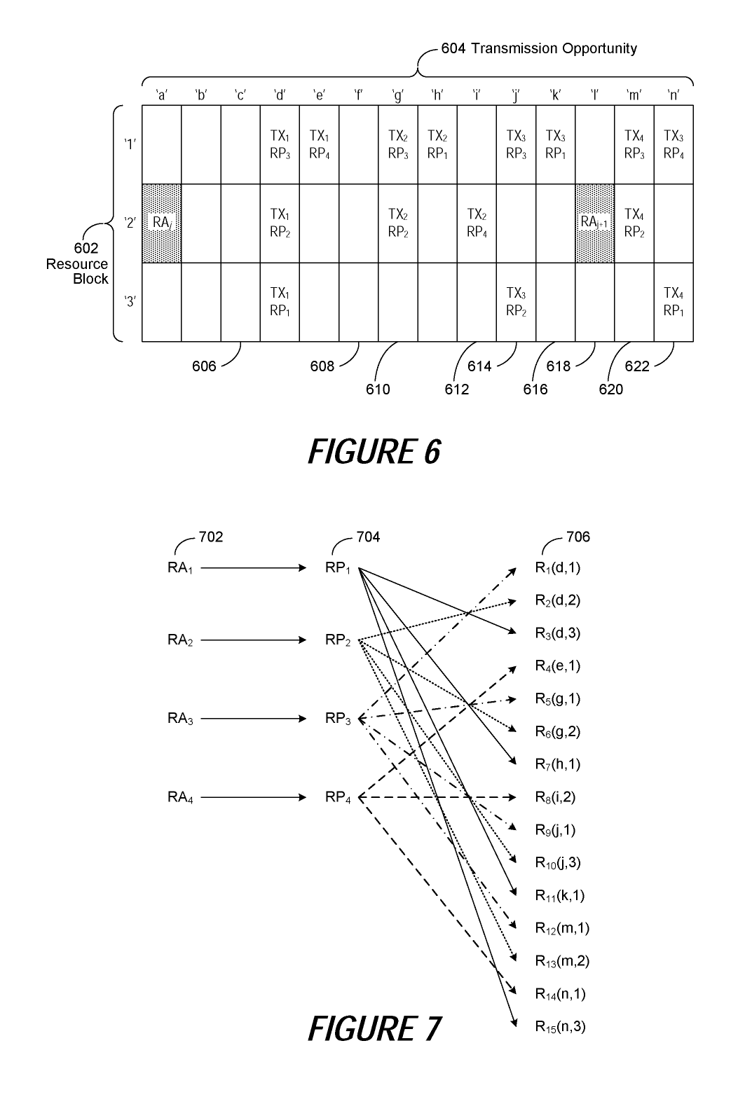

FIG. 6 shows random access (RA) sequences, associated transmission opportunities, and corresponding ACKs for an uplink (UL) RA data channel implemented in accordance with an embodiment of the disclosure to utilize Hybrid Automatic Repeat reQuest (HARQ). As shown in FIG. 6, resource blocks 602 ‘1’ through ‘3’ (i.e., ‘resources’) refer to a carrier, subcarrier, or sets of subcarriers, which may be disjoint or contiguous dependent upon various embodiments. The resource blocks may also refer to other radio resources such as spatial dimensions, beams, spreading codes, hierarchical modulation layers, and so on. Likewise, transmission opportunities are aligned with time slots 604 ‘a’ through ‘n’ which may be frames, subframes, or symbols, which are likewise dependent upon various embodiments. In this embodiment, a mobile station (MS) selects a RA sequence and transmits the sequence during an RA opportunity. For example, RA opportunity ‘RAⱼ’ shown in FIG. 6 as occurring in transmission opportunity (i.e., time slot) ‘a’ and using resource block ‘2’. In certain embodiments, the RA transmission opportunity 604 ‘a’ does not require the entire duration of a time slot, but may instead only occupy a portion of it. For example, the RA transmission opportunity 604 ‘a’ may only require a few symbols. Accordingly, if the MS receives an RA ACK of the RA sequence transmission, then the MS proceeds to transmit its data according to the resource pattern associated with that sequence. For example, if RA sequence ‘1’ was sent by the MS, the associated pattern may be RP ‘1’. Likewise, if RA sequence ‘2’ is sent by the MS, then the associated pattern may be RP ‘2’ and so on.

In the embodiment shown in FIG. 6, the transmission opportunity 604 ‘RAⱼ’ is in time slot ‘a’, using resource block ‘2’. The first transmission opportunity for each of the resource patterns associated with each RA sequence occurs at least M time slots after the RA transmission opportunity in order to allow time for the AP to receive the RA sequences and to send an RA ACK. In addition, the delay between successive data transmission opportunities is at least N time slots in order to allow the AP to attempt to decode the packet transmission, and send either a positive or negative HARQ acknowledgment. If a positive HARQ acknowledgement is received by the MS, then it will not send any more transmissions of the data. Likewise, if a negative HARQ acknowledgement is received, then the MS sends the next HARQ transmission of the data. In certain embodiments, a negative HARQ acknowledgement may not be sent.

As shown in FIG. 6, M=2, N=3, RA ACKs transmitted on DL in time slot 606 are associated with RP_{1,2,3,4}, NAK/ACKs transmitted on DL in time slot 608 are associated with TX₁ of RP_{1,2,3}, NAK/ACKs transmitted on DL in time slot 610 is associated with TX₁ of RP₄, and NAK/ACKs transmitted on DL in time slot 612 is associated with TX₂ of RP₁. Likewise, NAK/ACKs transmitted on DL in time slot 614 is associated with TX₂ of RP₁, NAK/ACKs transmitted on DL in time slot 616 is associated with TX₂ of RP₄, NAK/ACKs transmitted on DL in time slot 618 are associated with TX₃ of RP₃ and TX₃ of RP₂, NAK/ACKs transmitted on DL in time slot 620 is associated with TX₃ of RP₁, and NAK/ACKs transmitted on DL in time slot 622 is associated with TX₄ of RP₃.

FIG. 7 is a simplified schematic diagram showing the relationship between random access (RA) sequences, resource patterns (RP), and UL resources (R) associated with the RA data channel shown in FIG. 6. As shown in FIGS. 6 and 7, resource patterns can be made unique in that different patterns do not occupy the same frequency resource at any given time slot (i.e., transmission opportunities 604 ‘a’ through ‘n’).

Referring now to FIG. 7, the relationship between RA sequences 702, resources patterns (RP) 704, and UL resources (R) 706 is shown. As shown in FIG. 7, RA sequence ‘1’ (RA₁) is associated with resource pattern ‘1’ (RP₁), which in turn comprises opportunities for transmission on the UL at resources R₃, R₇, R₁₁ and R₁₅. Likewise, RA sequence ‘2’ (RA₂) is associated with resource pattern ‘2’ (RP₂), which in turn comprises opportunities for transmission on the UL at resources R₂, R₆, R₁₀ and R₁₃. As likewise shown in FIG. 7, RA sequence ‘3’ (RA₃) is associated with resource pattern ‘3’ (RP₃), which in turn comprises opportunities for transmission on the UL at resources R₁, R₅, R₉ and R₁₂. Likewise, RA sequence ‘4’ (RA₄) is associated with resource pattern ‘4’ (RP₄), which in turn comprises opportunities for transmission on the UL at resources R₄, R₈, and R₁₄.

In certain embodiments, the resource patterns associated with different RA sequences may not be completely unique such that one or more of the transmission opportunities associated with a given RA sequence overlaps, at least partially, with the resources of transmission opportunities associated with a different RA sequence. In certain embodiments, each resource block 602 is associated with multiple RA sequences.

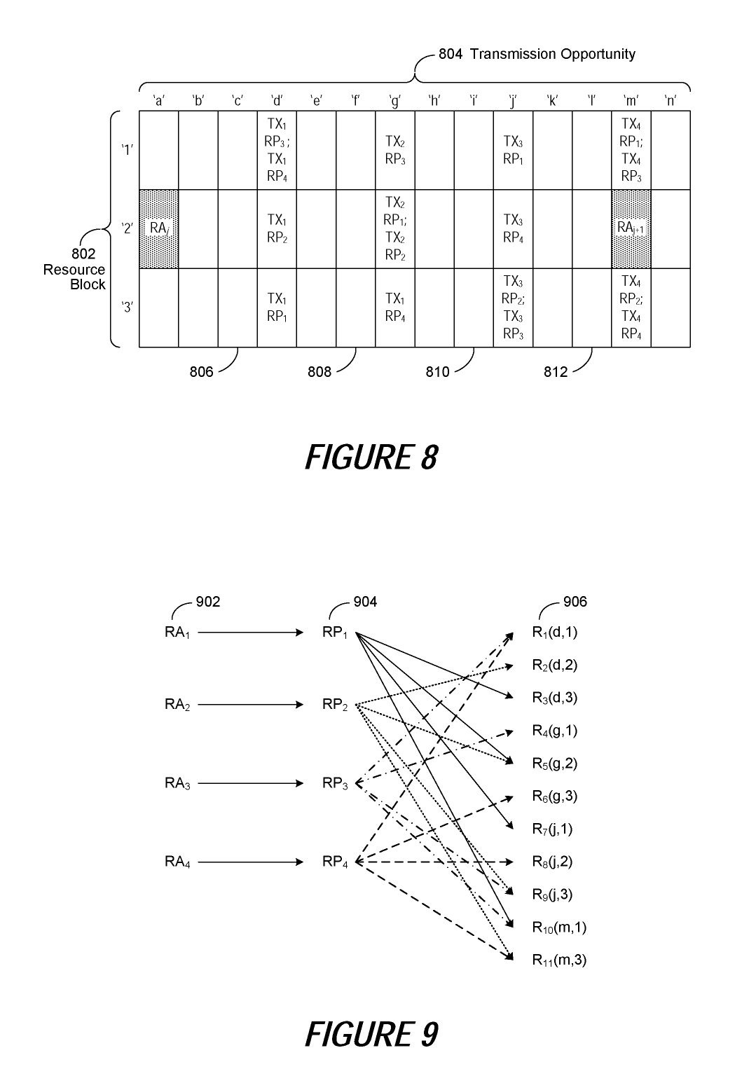

FIG. 8 shows random access (RA) sequences, associated transmission opportunities configured in the same time slot, and corresponding ACKs for an uplink (UL) RA data channel implemented in accordance with an embodiment of the disclosure to utilize Hybrid Automatic Repeat reQuest (HARQ). As shown in FIG. 8, resource blocks 802 ‘1’ through ‘3’ (i.e., ‘resources’) refer to a carrier, subcarrier, or sets of subcarriers, which may be disjoint or contiguous dependent upon various embodiments. Likewise, transmission opportunities are aligned with time slots 804 ‘a’ through ‘n’ which may be frames, subframes, or symbols, which are likewise dependent upon various embodiments. In this embodiment, multiple resource patterns (RPs) are assigned to a time-frequency resource in some instances. Likewise, the resources 802 designated for RA data channel transmission opportunities are confined to selected time slots. In this and various other embodiments, RA data channel opportunities are interleaved with synchronous Hybrid Automatic Repeat reQuest (HARQ) opportunities. In these various embodiments, a synchronous HARQ opportunity refers to HARQ retransmission opportunities that occur at known or periodically occurring time slots.

Referring now to FIG. 8, transmission opportunities 804 ‘b’, ‘e’, ‘h’, ‘k’ and ‘n’ are a first set of synchronous HARQ retransmission channels and transmission opportunities 804 ‘c’, ‘f’, ‘i’, and ‘1’ are a second set of synchronous HARQ retransmission channels. As shown in FIG. 8, this approach enables the synchronous HARQ retransmissions using the RA data channel in transmission opportunities 804 ‘d’, ‘g’, ‘j’, and ‘m’ for transmissions associated with those resources. In certain embodiments, the retransmission may occupy the same resources for all HARQ transmissions. As shown in FIG. 8, RA ACKs transmitted on DL in time slot 806 are associated with all RPs, NAK/ACKs transmitted on DL in time slot 808 are associated with TX₁ of all RPs, NAK/ACKs transmitted on DL in time slot 810 are associated with TX₂ of all RPs, and NAK/ACKs transmitted on DL in time slot 812 are associated with TX₃ of all RPs.

Likewise, the transmission opportunities associated with an RA sequence may continue in some embodiments to be defined in subsequent time slots after the transmission opportunities for other RA sequences have completed. For example, a fourth resource pattern ‘4’ may have a fifth and sixth transmission opportunity defined in time slots ‘p’ and ‘s’, which are concurrent with transmission patterns associated with new RA sequences RAⱼ₊₁ sent in 804 ‘m’.

FIG. 9 is a simplified schematic diagram showing the relationship between random access (RA) sequences, resource patterns (RP), and UL resources (R) associated with the RA data channels shown in FIG. 8. As shown in FIGS. 8 and 9, the resources designated in advance for the RA data channels are both minimized and grouped. It will be appreciated that minimization of the these resources may be useful as a larger cyclic prefix, guard time, or subcarriers may be needed to allow for proper reception of the UL signals for mobile stations that are unsynchronized. Likewise, larger prefixes, guard intervals, or other mechanism may reduce the efficiency of the transmission in comparison to time slots for UL transmission from synchronized mobile stations. However, if UL RA resources are not claimed by any MS, then the AP may schedule use of those RA resources and the resources in the guard intervals by mobile stations that are synchronized and able to use a smaller cyclic prefix.

Referring now to FIG. 9, the relationship between RA sequences 902, resources patterns (RP) 904, and UL resources (R) 906 is shown. As shown in FIG. 9, RA sequence ‘1’ (RA₁) is associated with resource pattern ‘1’ (RP₁), which in turn comprises opportunities for transmission on the UL at resources R₃, R₅, R₇ and R₁₀. Likewise, RA sequence ‘2’ (RA₂) is associated with resource pattern ‘2’ (RP₂), which in turn comprises opportunities for transmission on the UL at resources R₂, R₅, R₉ and R₁₁. As likewise shown in FIG. 7, RA sequence ‘3’ (RA3) is associated with resource pattern ‘3’ (RP₃), which in turn comprises opportunities for transmission on the UL at resources R₁, R₄, R₉ and R₁₀. Likewise, RA sequence ‘4’ (RA₄) is associated with resource pattern ‘4’ (R1³₄), which in turn comprises opportunities for transmission on the UL at resources R₁, R₆, R₈, and R₁₁.

FIG. 10 is an expanded Orthogonal Frequency-Division Multiple Access (OFDMA) subframe view of transmission opportunities ‘f’, ‘g’ and ‘h’ shown in FIG. 8. As shown in FIG. 10, transmission opportunities 1004 ‘f’ and ‘h’ correspond to a regular subframe 1008. As likewise shown in FIG. 10, the regular subframes 1008 comprise a plurality of Orthogonal Frequency Division Multiplexing (OFDM) symbols 1016, each associated with a cyclic prefix 1014. Likewise, transmission opportunity 1004 ‘g’ corresponds to a UL RA Data CHannel (UL RA DCH) subframe 1010. In turn, the UL RA DCH subframe 1010 comprises a plurality of UL RA DCH OFDM symbols 1020, each associated with a cyclic prefix 1018.

In some embodiments, the arrival of uplink (UL) transmissions from different mobile stations at an access point (AP) may not be synchronized due to different propagation delays, or timing offsets, used at each mobile station (MS). In these and other embodiments, the arrival of the random access (RA) sequence can be used by the AP to estimate the timing of further transmissions. For example, the RA sequence is received by the AP at time T₀=T_{off}_{_{—}}_{MS}+T_{AP}_{_{—}}_{frame}, where T_{off}_{_{—}}_{MS} is the time offset of the MS in comparison to the n^{th} AP UL frame time. If the expected first transmission associated with the RA resource pattern is to be sent in the n^{th}+5 frame, the AP can derive that the transmission will arrive at T₂=T_{off}_{_{—}}_{MS}+T_{AP}_{_{—}}_{frame}(n+5). This simplifies the reception process, as determining timing by searching for one of a set of RA sequences is less computationally expensive than searching for the unknown timing of a data transmission. Furthermore, other properties received or derived from the reception of the RA sequence, such as channel estimation or receive direction, may assist with reception of the data transmission as well as the separation of data transmissions from multiple mobile stations.

Likewise, if the data transmissions of unsynchronized mobiles are received using OFDM, appropriate guard subcarriers and filtering at the AP may be necessary. For example, FIG. 10 shows the implementation of a guard time 1024 and guard bands 1022, in the form of subcarriers, within subframe 1004 ‘g’, which is used for the UL RA DCH subframe 1010. Those of skill in the art will recognize that the implementation of the guard time 1024 is useful as the UL transmission from unsynchronized mobile stations may arrive delayed (e.g., due to unsynchronized UL timing) in comparison to the subframe timing at the AP. By allocating guard (i.e., empty) time 1024 within the subframe 1004 (e.g. at the beginning of the subframe, at the end of the subframe, or both), transmissions from mobile stations that are significantly delayed will not overlap into the next subframe. For example, without the guard time 1024, a delayed transmission of subframe 1004 ‘g’ may be received at the AP at the beginning of subframe 1004 ‘h’ and interfere with communications within that subframe.

FIG. 10 likewise shows the presence of guard bands 1022 between resource blocks 1002 to minimize interference. In OFDM systems, these guard bands 1022 are implemented as unused subcarriers to provide frequency separation between data transmitted in adjacent resource blocks 1002 (e.g., resource blocks ‘1’ and ‘2’), which may be assigned to different mobile stations with significantly different UL timing. If the guard bands 1022 are not used, and the UL arrival timing of transmissions in adjacent resources are longer than the cyclic prefix in the OFDM system, the adjacent subcarriers will significantly interfere with each other as the orthogonality between subcarriers of the different resource blocks 1002 would be lost.

It will be appreciated that while the UL RA DCH 1010 and associated guard time 1024 and subcarriers have been applied to the entire subframe, it is possible to apply the modifications of fewer symbols, guard time 1024 and subcarriers to a single resource block 1002 of a subframe rather than all resource blocks of a subframe. While FIG. 10 shows an embodiment implementing OFDMA symbols 1016 and cyclic prefixes 1014, this implementation of timing offset and a guard time 1024 is likewise applicable to Time Division Multiple Access (TDMA) or Frequency Division Multiple Access (FDMA) systems. Likewise, guard bands 1024 may also be used in non-OFDM systems to aid in filtering different resource blocks 1002.

It will also be appreciated that while the UL RA DCH 1010 subframes are shown with additional guard time 1024 and guard bands 1022, in some embodiments, the UL RA DCH 1010 subframes can be implemented without guard time 1024 or guard band 1022 where the arrival of uplink (UL) transmissions from different mobile stations at an access point (AP) are synchronized within the duration of the cyclic prefix,. In these embodiments, the UL RA DCH 1010 subframe would have the same timings and structure as regular subframes ‘f’ or ‘h’ 1008.

FIG. 11 is an expanded view of Orthogonal Frequency-Division Multiple Access (OFDMA) subframe ‘g’ shown in FIG. 10. As shown in FIG. 11, the uplink (UL) random access (RA) Data CHannel (UL RA DCH) subframe 1010 comprises a plurality of UL RA DCH Orthogonal Frequency Division Multiplexing (OFDM) symbols 1020 and their associated cyclic prefixes 1018. As likewise shown in FIG. 11, UL RA DCH transmissions from different mobile stations arrive with corresponding delays Δt₁ 1108, Δt₂ 1110, and Δt₃ 1112, on each resource segment 1002 ‘1’, ‘2’ and ‘3’. Likewise, FIG. 11 shows that the relative mobile station (MS) delays are greater than the cyclic prefix 1018 for symbols 1020 transmitted in subframe ‘g’.

In this and various other embodiments, the guard bands 1022 prevent inter-carrier interference from adjacent sub-bands that cannot be easily demodulated together. However, as the time offset, T_{off}_{_{—}}_{MS}=Δt₁ 1108, Δt₂ 1110, and Δt₃ 1112 from each MS transmission is known by the access point (AP) from the reception of the random access (RA) sequence prior to the data transmission, the AP can appropriately estimate the timing of the UL transmission without further delay estimation.

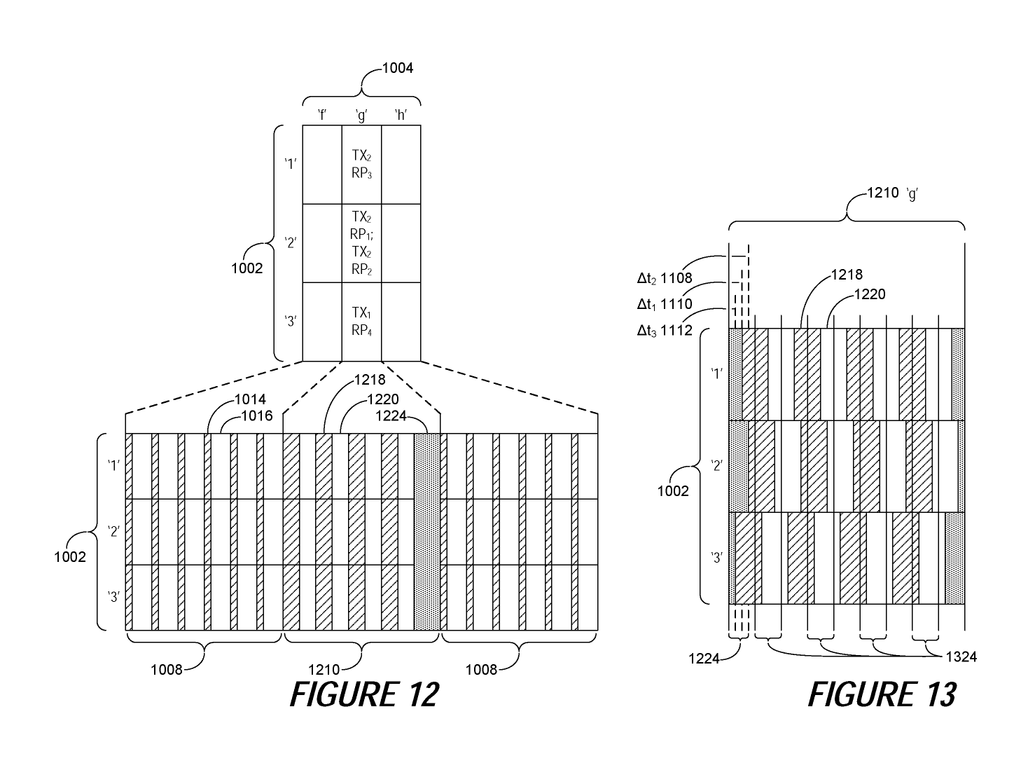

FIG. 12 is an expanded Orthogonal Frequency-Division Multiple Access (OFDMA) subframe view of transmission opportunities ‘f’, ‘g’ and ‘h’ shown in FIG. 8, showing a configuration with extended cyclic prefixes and subframe guard time. As shown in FIG. 12, transmission opportunities 1004 ‘f’ and ‘h’ correspond to a regular subframe 1008. As likewise shown in FIG. 12, the regular subframes 1008 comprise a plurality of Orthogonal Frequency Division Multiplexing (OFDM) symbols 1016 and associated cyclic prefixes 1014. Likewise, transmission opportunity 1004 ‘g’ corresponds to a UL RA data channel (UL RA DCH) subframe 1210. In turn, the uplink (UL) random access (RA) Data CHannel (UL RA DCH) subframe 1210 comprises a plurality of UL RA DCH OFDM symbols 1220 and associated cyclic prefixes 1218. As shown in FIG. 12, the number of UL RA DCH OFDM symbols 1220 and associated cycle prefixes 1218 is fewer than the number of OFDM symbols 1016 and associated cyclic prefixes 1014 found in a regular subframe 1008.

In various embodiments, uplink (UL) data transmission opportunities are configured to have longer cyclic prefixes 1218 for the OFDM symbols 1220 when transmission delay is not significant in comparison to the duration of the OFDM symbols 1220. In these various embodiments, the configuration of longer cyclic prefixes 1218 reduces the number of OFDM symbols 1220 available in the UL RA DCH in comparison to the number of OFDM symbols used in regular subframes of the system. However, the use of longer cyclic prefixes 1218 enables transmissions from different mobile stations with a wider range of UL timing offsets to be received synchronously.

As shown in FIG. 12, the cyclic prefix 1218 can be extended and the number of OFDM symbols 1220 reduced within the UL RA DCH subframe (e.g., subframe 1210). Those of skill in the art will realize that the longer cyclic prefix 1218 allows for portions of the OFDM symbol 1220 (e.g. resources blocks 1002) that have significantly different delays, to be combined and demodulated using conventional OFDM receivers (e.g. Fast Fourier Transform) at the access point (AP) as the delays are still less the cyclic prefix 1218. Likewise, the orthogonality between the subcarriers of different resource blocks 1002 would be lost without this extended cyclic prefix 1218 if resources blocks of the same OFDM symbol 1220 are received at a timing offset greater than the cyclic prefix 1218. Accordingly, a guard time interval 1224 can be optionally used at the end of the subframe 1210 ‘g’ to realign with the start of a regular subframe (e.g., regular subframe ‘h’ 1008) and to prevent significantly delayed signals from the g^{th} subframe interfering with those received in the h^{t h} subframe.

FIG. 13 is an expanded Orthogonal Frequency-Division Multiple Access (OFDMA) view of subframe ‘g’ shown in FIG. 12. As shown in FIG. 13, uplink (UL) random access (RA) Data CHannel (UL RA DCH) subframe 1210 comprises a plurality of UL RA DCH Orthogonal Frequency Division Multiplexing (OFDM) symbols 1220 and their associated cyclic prefixes 1218. As likewise shown in FIG. 11, UL RA DCH transmissions from different mobile stations arrive with corresponding delays Δt₁ 1108, Δt₂ 1110, and Δt₃ 1112, on each resource segment 1002 ‘1’, ‘2’ and ‘3’, which provides guard time 1224. Likewise, FIG. 13 shows that the relative mobile station (MS) delays 1108, 1110, and 1112 are less than the cyclic prefix 1218 for symbols 1220 transmitted in subframe ‘g’. Accordingly, the OFDM symbols 1220 can be properly demodulated without inter-carrier interference as the symbols 1220 from each resource segment 1002 are sufficiently aligned such that only one symbol 1220 from each resource segment 1002 is present within each of the OFDM symbol receiver windows 1324.

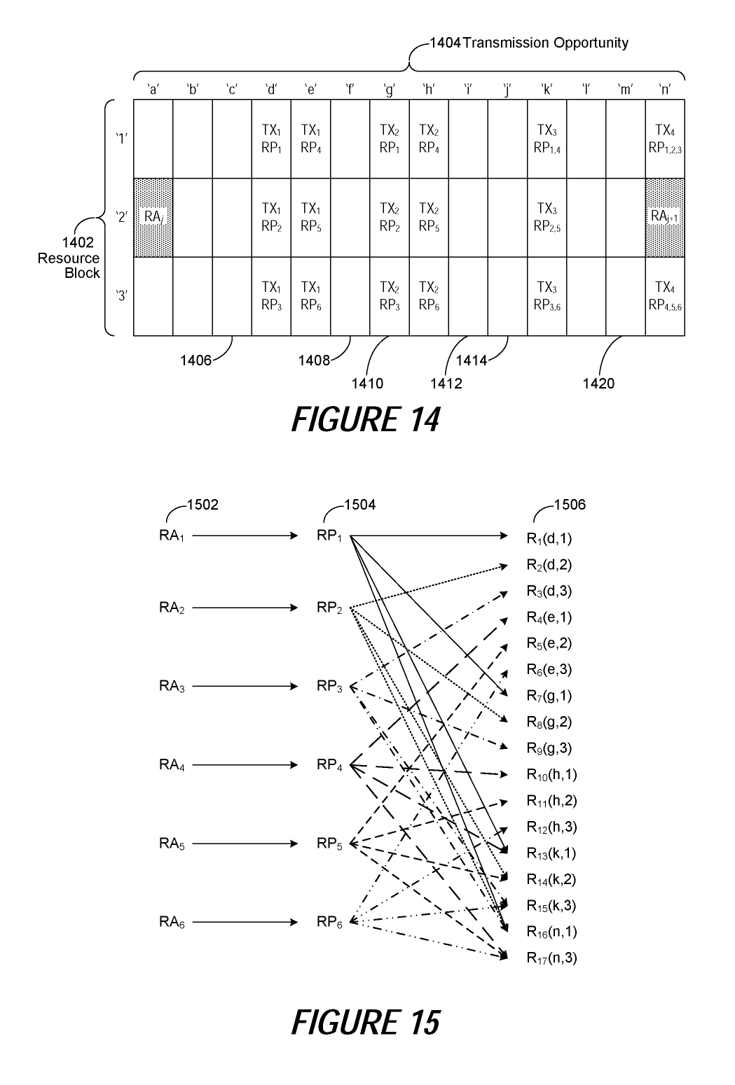

FIG. 14 shows random access (RA) sequences, associated transmission opportunities, and corresponding ACKs for an uplink (UL) RA data channel as implemented in accordance with an embodiment of the disclosure where the number of dedicated random access resources is varied in each Hybrid Automatic Repeat reQuest (HARQ) transmission opportunity. As shown in FIG. 14, resource blocks 1402 ‘1’ through ‘3’ (i.e., ‘resources’) refer to a carrier, subcarrier, or sets of subcarriers, which may be disjoint or contiguous dependent upon various embodiments. Likewise, transmission opportunities 1404 ‘a’ through ‘n’ refer to frames, subframes, or symbols, which are likewise dependent upon various embodiments. In various embodiments, the number of resource patterns that use a given resource 1402 is dependent upon the number of HARQ transmissions. In certain of these embodiments, the number of resources 1402 allocated for all resources patterns varies with each successive HARQ transmission opportunity 1404. For example, as the number of HARQ transmissions increases there is an increasing probability that a HARQ transmission has been successfully received. Accordingly, if six (6) HARQ transmissions are begun, perhaps only three (3) require a 3^{rd} HARQ re-transmission, and even fewer require a fourth re-transmission. Hence, it may not be necessary to have as many resources 1402 allocated for the resource patterns for the last few HARQ transmission as for the first few HARQ transmissions.

As shown in FIG. 14, there are six (6) resource patterns (‘RP ₁’ through ‘RP₆’), all with unique resources 1402 for the first two HARQ transmissions, respectively occurring within transmission opportunities ‘d’, ‘e’ and ‘g’, ‘h’. As it is likely that one or more HARQ processes will have stopped prior to the third transmission, occurring within transmission opportunity ‘k’, the number of resources 1402 dedicated for use by the RA data channels can be reduced. As likewise shown in FIG. 14, the six (6) resource patterns share three (3) resources for the 3^{rd} HARQ transmission occurring within transmission opportunity ‘k’. Further, even fewer resources are likely to be needed in the 4^{th} re-transmission, such that the six (6) resource patterns share two (2) resources. It will be appreciated that different sets of resource patterns interfere with each other in the third and fourth HARQ retransmissions to allow for interference diversity. As shown in FIG. 14, RA ACKs transmitted on DL in time slot 1406 are associated with all RPs, NAK/ACKs transmitted on DL in time slot 1408 are associated with TX₁ of RP_{1,2,3}, NAK/ACKs transmitted on DL in time slot 1410 are associated with TX₁ of RP_{4,5,6}, NAK/ACKs transmitted on DL in time slot 1412 are associated with TX₂ of RP_{1,2,3}, NAK/ACKs transmitted on DL in time slot 1414 are associated with TX₂ of RP_{4,5,6}, and NAK/ACKs transmitted on DL in time slot 1420 are associated with TX₃ of all RPs.

FIG. 15 is a simplified schematic diagram showing the relationship between random access (RA) sequences, resources patterns (RPs), and UL resources (R) associated with the random access (RA) data channels shown in FIG. 14. Referring now to FIG. 15, the relationship between RA sequences 1502, resources patterns (RP) 1504, and UL resources (R) 1506 is shown. As shown in FIG. 15, RA sequence ‘1’ (RAO) is associated with resource pattern ‘1’ (RP₁), which in turn comprises opportunities for transmission on the UL at resources R₁, R₇, R₁₃ and R₁₆. Likewise, RA sequence ‘2’ (RA₂) is associated with resource pattern ‘2’ (RP₂), which in turn comprises opportunities for transmission on the UL at resources R₂, R₈, R₁₄ and R₁₆. As likewise shown in FIG. 15, RA sequence ‘3’ (RA₃) is associated with resource pattern ‘3’ (RP₃), which in turn comprises opportunities for transmission on the UL at resources R₃, R₈, R₁₅ and R₁₆. Likewise, RA sequence ‘4’ (RA₄) is associated with resource pattern ‘4’ (R1³₄), which in turn comprises opportunities for transmission on the UL at resources R₄, R₁₀, R₁₃ and R₁₇. Likewise, as shown in FIG. 15, RA sequence ‘5’ (RA₅) is associated with resource pattern ‘5’ (RP₅), which in turn comprises opportunities for transmission on the UL at resources R₅, R₁₁, R₁₄ and R₁₇. Likewise, RA sequence ‘6’ (RA₆) is associated with resource pattern ‘6’ (RP₆), which in turn comprises opportunities for transmission on the UL at resources R₆, R₁₂, R₁₄ and R₁₇.

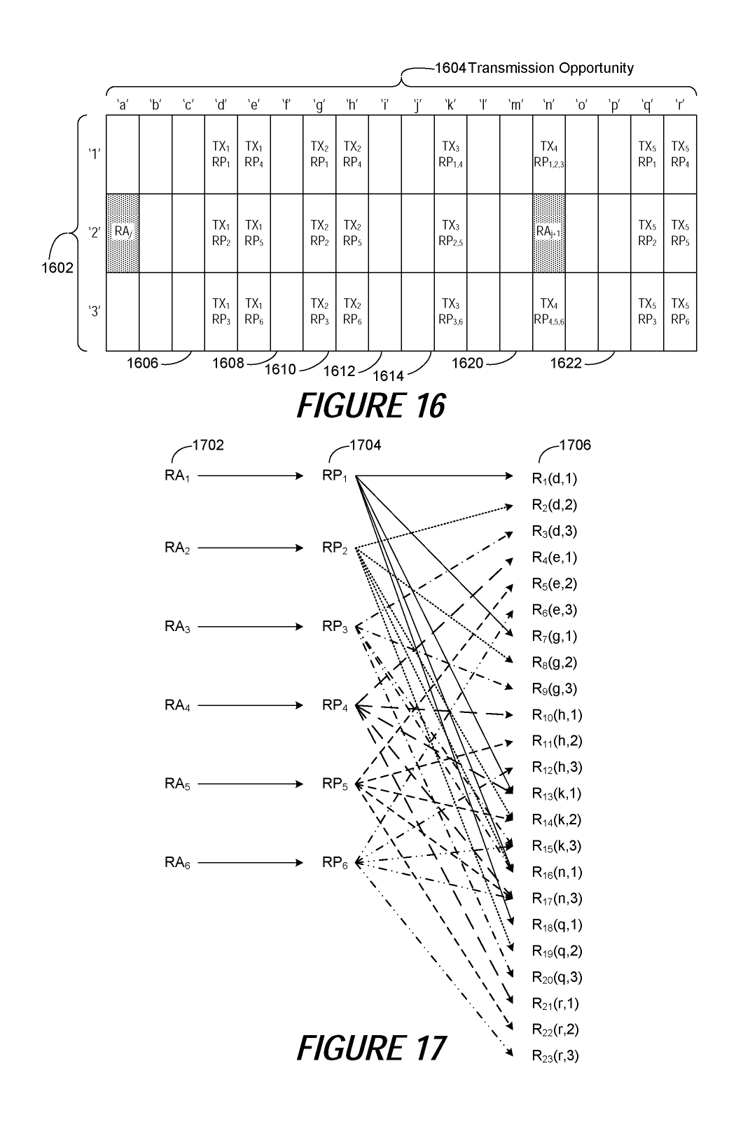

FIG. 16 shows random access (RA) sequences, associated transmission opportunities, and corresponding ACKs for uplink (UL) RA data channels as implemented in accordance with an embodiment of the disclosure to decrease the number of dedicated resources for all resource patterns (RPs) in each successive Hybrid Automatic Repeat reQuest (HARQ) transmission, with increased resources for a final transmission opportunity. As shown in FIG. 16, resource blocks 1602 ‘1’ through ‘3’ (i.e., ‘resources’) refer to a carrier, subcarrier, or sets of subcarriers, which may be disjoint or contiguous dependent upon various embodiments. Likewise, transmission opportunities 1604 ‘a’ through ‘n’ refer to frames, subframes, or symbols, which are likewise dependent upon various embodiments. In this embodiment, a HARQ transmission has a better chance of being completed successfully as the number of retransmissions progress. Accordingly, the number of resources 1602 allocated for all resource patterns is decreased in successive HARQ transmission opportunities. However, it will be appreciated that it is advantageous in certain of these embodiments to allow for a final set of transmissions to be sent with lower probability of interference from other HARQ processes to improve the probability of completing the data transmission successfully. Accordingly, in these embodiments, the number of resources 1602 allocated for all resource patterns is increased in successive HARQ transmission opportunities past a predetermined point.

As likewise shown in FIG. 16, there are six (6) resource patterns (‘RP₁’ through ‘RP₆’), all with unique resources 1602 for the first two HARQ transmission opportunities, respectively occurring within transmission opportunities ‘d’, ‘e’ and ‘g’, ‘h’. Likewise, these resources are reduced to a total of three (3) resources 1602 for the third HARQ transmission opportunity, which occurs in transmission opportunity ‘k’, and to two (2) resources 1602 for the fourth HARQ transmission opportunity, which occurs in transmission opportunity ‘n’. For the final and fifth HARQ transmission opportunities, the number of resources 1602 is increased to six (6) resources 1602 to allow each resource pattern an exclusive resource 1602 without interference from the other HARQ processes. As the probability that a HARQ process will reach its final transmission opportunity 1604 is generally quite small in most designs, it is likely that these resources 1602 will be reassigned using another method as described in greater detail herein. As shown in FIG. 16, RA ACKs transmitted on DL in time slot 1606 are associated with all RPs, NACK/ACKs transmitted on DL in time slot 1608 are associated with TX₁ of RP_{1,2,3}, NACK/ACKs transmitted on DL in time slot 1610 are associated with TX₁ of RP_{4,5,6}, NACK/ACKs transmitted on DL in time slot 1612 are associated with TX₂ of RP_{1,2,3}, NACK/ACKs transmitted on DL in time slot 1614 are associated with TX₂ of RP_{4,5,6}, NACK/ACKs transmitted on DL in time slot 1620 are associated with TX₃ of all RPs, and NACK/ACKs transmitted on DL in time slot 1622 are associated with TX₄ of all RPs.

FIG. 17 is a simplified schematic diagram showing the relationship between random access (RA) sequences, resources patterns (RP), and UL resources (R) associated with the random access (RA) data channels shown in FIG. 16. Referring now to FIG. 17, the relationship between RA sequences 1702, resources patterns (RP) 1704, and UL resources (R) 1706 is shown. As shown in FIG. 17, RA sequence ‘1’ (RA₁) is associated with resource pattern ‘1’ (RP₁), which in turn comprises opportunities for transmission on the UL at resources R₁, R₇, R₁₃, R₁₆ and R₁₈. Likewise, RA sequence ‘2’ (RA₂) is associated with resource pattern ‘2’ (RP₂), which in turn comprises opportunities for transmission on the UL at resources R₂, R₈, R₁₄, R₁₆ and R₁₉. As likewise shown in FIG. 15, RA sequence ‘3’ (RA₃) is associated with resource pattern ‘3’ (RP₃), which in turn comprises opportunities for transmission on the UL at resources R₃, R₉, R₁₅, R₁₆ and R₂₀. Likewise, RA sequence ‘4’ (RA₄) is associated with resource pattern ‘4’ (RP₄), which in turn comprises opportunities for transmission on the UL at resources R₄, R₁₀, R₁₃, R₁₇ and R₂₁. Likewise, as shown in FIG. 15, RA sequence ‘5’ (RA₅) is associated with resource pattern ‘5’ (RP₅), which in turn comprises opportunities for transmission on the UL at resources R₅, R₁₁, R₁₄, R₁₇ and R₂₂. Likewise, RA sequence ‘6’ (RA₆) is associated with resource pattern ‘6’ (RP₆), which in turn comprises opportunities for transmission on the UL at resources R₆, R₁₂, R₁₅, R₁₇ and R₂₃.

In various embodiments the mobile station (MS) ID can be included in a control message transmitted on the resource pattern resources. In certain of these embodiments, it is encoded with the data packet such that it may benefit from HARQ retransmissions. The MS ID may be a global ID that is permanently associated with the MS, a shortened hash of the global ID, or a temporary ID, such as a Radio Network Temporary Identifier (RNTI) in LTE, issued by the access point (AP) potentially on initial access to the system. The MS ID is sent in a predetermined portion of the data packet (e.g., the beginning) so it can be recognized by the AP. After its reception, the AP can further use this ID or known derivation of it to communicate on the downlink (DL) with the MS, which may include assigning UL resources to the MS through a UL access grant on DL, sending a UL timing adjustment message to the MS on the DL, and properly processing the information sent on UL in accordance with the MS's established identity.

In various embodiments, multiple mobile stations may transmit the same RA sequence in the same resource. In these embodiments, the HARQ transmissions will continue to collide until one MS is assigned a different pattern and resource. Accordingly, the following AP reception cases may result when two mobile stations select and send the i^{th} RA sequence:

1. Two transmissions of the same RA sequence were sent by two mobile stations, yet the AP perceives no RA sequence. In this embodiment, the AP does not send a positive RA ACK as it is unaware of a transmission. As a result, the mobile stations may individually select another RA sequence randomly and begin again at the next opportunity.

2. The AP detects two of the same RA sequence transmissions, where identification of multiple RA sequences occurs through timing offset, spatial division, joint power level detection, or other means. In one embodiment, the AP does not positively acknowledge the RA sequence to avoid having to separate data transmissions that will interfere. In this embodiment, the mobile stations may individually select another RA sequence randomly and begin again at the next opportunity. In another embodiment, the AP ACKs the RA sequence, and continues to attempt to separate the two simultaneous data transmissions.

3. The AP perceives only one RA sequence, whereas two of the same RA sequence transmissions where sent by two different Mobile stations. The AP sends one RA ACK as it is not aware of the conflict. The AP proceeds to NAK HARQ data transmissions which it does not receive correctly. If neither HARQ data transmission is received correctly, and the maximum number of HARQ data transmissions have been attempted, both data transmissions will fail. The mobile stations may individually select another RA sequence randomly and begin again at the next opportunity.

In various embodiments, if one HARQ data transmission is correctly received, the AP may send a positive ACK. If the system is configured such that the ACK is addressed to the RA sequence ID, then both HARQ data transmission processes will stop, on the assumption they have succeeded, even though only one has been received correctly. It will be appreciated that higher layer protocols are required to determine which MS was successful and which one was not. If the system is configured such that the ACK is addressed to the MS ID sent with the data packet, then only the successful HARQ data transmission process will stop transmissions, whereas the other will continue. In one embodiment, the AP is unaware of the other HARQ data transmission and hence the other HARQ data transmissions continue to the maximum number of HARQ transmissions at which point it fails. In another embodiment, the AP is unaware of the other HARQ data transmission. However, it nonetheless attempts to decode transmissions during the scheduled HARQ transmission opportunities in case another HARQ data transmission is occurring. In this embodiment, the AP may decode the HARQ data transmission and send an ACK before the maximum number of HARQ transmissions.

In one embodiment, the AP avoids random access conflicts by assigning a reserved RA sequence to an MS at some point prior to the random access attempt. For example, the AP may assign an RA sequence to an MS before it transitions to idle state or reduced activity. As another example, the serving AP may, in concert with a neighboring AP, assign an RA sequence to a MS to allow it to communicate with the neighboring AP for interference mitigation. It will be appreciated that the use of reserved RA sequences allows the MS to rapidly claim a pre-defined set of radio resources when the MS has information to transmit while allowing the AP to schedule those resources for other uses if they are not claimed by the MS. The set of radio resources in the resource pattern associated with the reserved RA sequence may be tailored to the specific needs of the Mobile Station.

In one embodiment, the system is configured such that the AP does not respond to a successfully decoded RA sequence with an ACK. Instead, the MS proceeds to transmit its data according the resource pattern associated with its chosen sequence. In this embodiment, the AP attempts to decode the potential HARQ transmissions from mobile stations according to the RPs for which RA sequences have been received. In this embodiment, the detection threshold for RA may be set significantly lower than for configurations where the APs send RA ACKs. In another embodiment, the RA ACK message also includes an indication of channel quality by which the MS selects its modulation format. In yet another embodiment, the AP indicates the modulation format the MS is to use in upcoming transmission.

In one embodiment, the RA ACK transmitted in response to receiving an RA sequence by the MS also contains a timing advance instruction from the AP. The MS applies the timing advance to its HARQ data transmissions in order to be properly time aligned to the UL frame at the AP. As this is sent to and obeyed by each MS, the mobile station's UL transmission may be generally aligned within a regular cyclic prefix. Therefore, guard times and extended cyclic prefixes as illustrated in FIGS. 9 and 10 are not required. In certain current systems, the response to a RA sequence includes a timing advance and an UL grant. Unlike such systems, the RA sequence is associated with a set of HARQ transmission opportunities in this embodiment. Accordingly, a UL grant is not required.

In various embodiments, it is possible that the AP perceives that only one RA sequence was sent when in fact two mobile stations happened to send an identical sequence. As this RA sequence is positively acknowledged, the two subsequent simultaneous HARQ data transmissions will occur on the same resources and interfere with each other. In one embodiment, the system is configured such that the mobile stations send their MS ID, or and identifier derived from it, along with the HARQ data transmission. However, the MS ID is coded and modulated separately in a more reliable manner so that it can be received in the presence of interference. Likewise, the MS ID is sent in a predetermined location of the HARQ data transmission such that the AP can properly recognize it. In this embodiment, the AP may be able to decode the MS IDs prior to decoding the data packet, and therefore be aware that two simultaneous HARQ data transmissions are taking place. Likewise, the AP can send a conflict resolution message to one or both of the mobile stations, instructing one or the other to stop transmissions on the UL RA Data CHannel (DCH) resource pattern. It will be appreciated that this approach may prevent the delays associated with both HARQ transmission processes sending the maximum number of HARQ data transmissions and failing.

As described in greater detail herein, various embodiments assign resource patterns to a MS based on the RA request sequence transmitted. The resource patterns define transmission resources for multiple potential HARQ data transmissions. Furthermore, the transmission resources comprising different patterns may not be assigned exclusively to that pattern. Therefore, the assigned pattern ensures that a given MS will potentially have inference from other mobile stations in each HARQ transmission opportunity providing a process which allows for interference diversity if multiple patterns are being used by multiple mobile stations. Furthermore, the number of resource patterns that occupy the same transmission resource can be changed with subsequent HARQ transmission opportunities to allow for either decreasing interference, or minimizing the number of resources used for this process.

Likewise, the HARQ data transmission may contain the MS ID, or an identifier derived from it, to facilitate initial access, or a “one-shot” type transmission where, using the method described, the MS transmits data to an AP with which it has not registered, and may not communicate with again. In one embodiment, the MS ID or identifier is sent with the data but encoded separately and more reliably than the data. In this embodiment, the MS ID can be identified without packet decoding to resolve conflicts.

Although the described exemplary embodiments disclosed herein are described with reference to managing random access data channels in a wirelessly-enabled communications environment, the present disclosure is not necessarily limited to the example embodiments which illustrate inventive aspects of the present disclosure that are applicable to a wide variety of authentication algorithms. Thus, the particular embodiments disclosed above are illustrative only and should not be taken as limitations upon the present disclosure, as the disclosure may be modified and practiced in different but equivalent manners apparent to those skilled in the art having the benefit of the teachings herein. Accordingly, the foregoing description is not intended to limit the disclosure to the particular form set forth, but on the contrary, is intended to cover such alternatives, modifications and equivalents as may be included within the spirit and scope of the disclosure as defined by the appended claims so that those skilled in the art should understand that they can make various changes, substitutions and alterations without departing from the spirit and scope of the disclosure in its broadest form.

What is claimed is:

1. A system for transmitting data over a random access (RA) data channel comprising:
a plurality of RA data channels, each RA data channel comprising:
a RA sequence associated with a corresponding RA sequence identifier;
a RA resource pattern (RP) comprising a set of uplink (UL) Hybrid Automatic Repeat reQuest (HARQ) transmission opportunities corresponding to a set of data transmission resources, each data transmission resource comprising a set of radio channel resources; and
a mobile station (MS) configured to:
select a RA data channel from the plurality of RA data channels;
transmit the RA sequence associated with the selected RA data channel to an access point (AP);
use the data transmission resources to transmit data to the AP during corresponding HARQ transmission opportunities of the RP associated with the selected RA data channel; and
receive a data transmission positive or negative acknowledgement from the AP.

2. The system of claim 1, wherein a number of RA data channels is increased or decreased by the AP according to traffic demand.

3. The system of claim 1, wherein a number of data transmission resources allocated to a first RP of the plurality of RPs is greater than a number of data transmission resources allocated to a second RP of the plurality of RPs.

4. The system of claim 1, wherein at least one of the data transmission resources from a first set of data transmission resources associated with a first RP of the plurality of RPs is included in a second set of data transmission resources associated with a second RP of the plurality of RPs.

5. The system of claim 4, wherein the number of RPs associated with an individual data transmission resource of the set of data transmission resources for a HARQ transmission opportunity varies for each HARQ transmission opportunity in the set of HARQ transmission opportunities.

6. The system of claim 1, wherein the set of radio channel resources comprise a restricted subset of the plurality of radio channel resources available on the radio channel.

7. The system of claim 1, wherein the AP is configured to re-allocate data transmission resources associated with an RP to other mobile stations when the RA sequence associated with the RP is not received by the AP.

8. The system of claim 1, wherein the AP is configured to re-allocate data transmission resources allocated for subsequent HARQ transmission opportunities in the RP to a second mobile station when the data transmission sent in a HARQ transmission opportunity of an RP is successfully decoded and positively acknowledged by the AP.

9. The system of claim 1, wherein the data transmission in at least the first HARQ transmission opportunity includes an MS identifier that is encoded or modulated separately from the data transmission.

10. The system of claim 9, wherein the AP is configured to signal a response to a data transmission sent during a HARQ transmission opportunity by transmitting an acknowledgement message, the acknowledgment message received by the MS and comprising one or more MS identifiers including at least the MS identifier associated with the data transmission.

11. The system of claim 1, wherein the data transmission in the HARQ transmission opportunity includes an MS identifier that is encoded and modulated with the data transmission.

12. The system of claim 11, wherein the AP is configured to signal a response to a data transmission sent during a HARQ transmission opportunity by transmitting an acknowledgement message, the acknowledgement message received by the MS and comprising one or more MS identifiers including at least the MS identifier associated with the data transmission.

13. The system of claim 1, wherein the AP is configured to communicate an indicator that one or more RA sequences of the plurality of RA sequences has been correctly received by the AP, wherein the indicator is received by the MS and the indicator comprises at least one of the set of:
a bit in an element of a control message associated with one or more of the RA sequences; and
a signal transmitted using a radio resource associated with one or more of the RA sequences.

14. The system of claim 1, wherein the AP is configured to communicate an acknowledgement message indicating that one or more RA sequences from the plurality of RA sequences has been correctly received by the AP, the acknowledgement message received by the MS and the acknowledgment message comprises a set of one or more RA sequence identifiers.

15. The system of claim 1, wherein the AP is configured to correctly receive the RA sequence and not send a positive acknowledgement message in response.

16. The system of claim 1, wherein the AP is configured to communicate an acknowledgment message associated with an RP sent during a HARQ transmission opportunity by transmitting an indicator received by the MS, the indicator comprising at least one of the set of:
a bit in an element of a control message associated with at least the RP; and
a signal transmitted using a radio resource associated with at least the RP.

17. The system of claim 1, wherein the AP is configured to communicate an acknowledgement message associated with an RP sent during one HARQ transmission opportunity by transmitting an indicator received by the MS, the indicator comprising a set of RA sequence identifiers including at least the RA sequence identifier associated with the RP.

18. The system of claim 1, wherein the AP is configured to confirm the reception of an RA sequence and the allocation of data transmission resources associated with the corresponding RP by transmitting an UL timing advance instruction to the MS.

19. The system of claim 1, wherein an individual data transmission resource is an Orthogonal Frequency Division Multiple Access (OFDMA) UL data transmission resource, the OFDMA UL data transmission resource comprising one or more OFDM sub-carriers, an extended guard band, an extended cyclic prefix, a reduced number of symbols, and an extended guard time.

20. The system of claim 19, wherein the AP is configured to compute a reception timing offset and use the reception timing offset to synchronize with the data transmissions sent by the MS in HARQ transmission opportunities, the reception timing offset comprising a difference between the start time of an OFDMA subframe and the arrival time of the RA sequence at the AP.

21. A method for transmitting data over a random access (RA) data channel of a plurality of RA data channels comprising:
associating a RA sequence with a corresponding RA sequence identifier;
providing a RA resource pattern (RP) comprising a set of uplink (UL) Hybrid Automatic Repeat reQuest (HARQ) transmission opportunities corresponding to a set of data transmission resources, each data transmission resource comprising a set of radio channel resources;
selecting a RA data channel from the plurality of RA data channels;
transmitting the RA sequence associated with the selected RA data channel to an access point (AP);
using the set of data transmission resources to transmit data to the AP during corresponding HARQ transmission opportunities of the RP associated with the selected RA data channel; and,
receiving a data transmission positive or negative acknowledgement from the AP.
